(19) United States
(12) Patent Application Publication
(10) Pub. No.: US 2020/0087467 A1
(43) Pub. Date: Mar. 19, 2020

(54) LASER-INDUCED GRAPHENE FORMATION IN POLYMER BLENDS

(71) Applicant: SABIC Global Technologies, B.V., Bergen op Zoom (NL)

(72) Inventors: Shahram Shafaei, Bergen op Zoom (NL); Kapil Chandrakant Sheth, Evansville, IN (US)

(21) Appl. No.: 16/569,096

(22) Filed: Sep. 12, 2019

(30) Foreign Application Priority Data
Sep. 14, 2018 (EP) 18194641.9

(51) Int. Cl. C08J 3/28; C08K 3/04

(52) U.S. Cl. CPC C08J 3/28; B82Y 30/00; C08K 3/042

(57) ABSTRACT

A method for forming a polymer/graphene nanocomposite includes providing a polymer blend comprising a polyetherimide and a polycarbonate; and irradiating the polymer blend with radiation comprising a wavelength in a range of 8.3 to 11 μm to provide the polymer/graphene nanocomposite. The polymer blend has a melt volume rate of 1 to 100 cm³/10 min, preferably 5 to 75 cm³/10 min, more preferably 10 to 50 cm³/10 min, as determined at 360° C./5.0 kg in accordance with ISO 1133.

### CROSS REFERENCE TO RELATED APPLICATIONS

This application claims priority to and the benefit of European Application No. 18194641.9, filed Sep. 14, 2018, and all the benefits accruing therefrom under 35 U.S.C. § 119, the content of which in its entirety is herein incorporated by reference.

### BACKGROUND

Polymer/graphene nanocomposites can have significantly improved properties, such as improved mechanical properties, thermal and electrical conductivities, and gas barrier properties. Distribution of the graphene within the polymer matrix, as well as the interfacial bonding between the graphene and the host matrix are key factors that can affect such properties. Mixing techniques to disperse graphene nanoparticles in a desired polymer matrix include solution casting, melt blending, in situ polymerization, electrospinning, and electrodeposition. Disadvantages of mixing techniques can include aggregation of the graphene nanoparticles, poor dispersion, and noncovalent interactions during the mixing.

Methods for the production of graphene in certain polymers using laser irradiation have been described. However, it would be a further advantage if the methods could be extended to provide a non-mixing processing method for incorporation of graphene in a variety of polymers, in particular polymers blends including a polyetherimide and a polycarbonate.

### BRIEF DESCRIPTION

A method for forming a polymer/graphene nanocomposite includes providing a polymer blend comprising a polyetherimide and a polycarbonate; and irradiating the polymer blend with radiation comprising a wavelength in a range of 8.3 to 11 μm, or 8.3 to 10.6 μm to provide the polymer/graphene nanocomposite. The polymer blend has a melt volume rate of 1 to 100 cm³/10 min, preferably 5 to 75 cm³/10 min, more preferably 10 to 50 cm³/10 min, as determined at 360° C./5.0 kg in accordance with ISO 1133.

A polymer/graphene nanocomposite made by the above method is disclosed.

A polymer/graphene nanocomposite comprises polymer-derived graphene and a polymer blend comprising a polyetherimide and a polycarbonate.

Articles comprising the polymer/graphene nanocomposite are disclosed.

The above described and other features are exemplified by the following figures and detailed description.

### BRIEF DESCRIPTION OF THE DRAWINGS

The following figures are exemplary embodiments wherein the like elements are numbered alike.

FIG. 1 is an SEM image of the laser irradiated polymer of Example 6;

FIG. 2 is an SEM image of the laser irradiated polymer of Example 6;

FIG. 3 is a Raman spectrum of the laser irradiated polymer of Example 6; and

FIG. 4 shows atomic force microscopy (AFM) images of polymer blend samples after laser irradiation.

### DETAILED DESCRIPTION

Adhesion of graphene particles on a polymer blend including polyetherimide and polycarbonate formed by laser irradiation of the polymer blend can be varied with differing viscosities of the polycarbonate. For example, relatively lower viscosity polycarbonates can provide improved adhesion of graphene particles on the polymer blend as compared to relatively higher viscosity polycarbonates. The polymer blend can also exhibit desirable electrical conductivity after laser irradiation.

Laser-induced graphene formation is a non-mixing method to produce polymer/graphene nanocomposites. Graphene as used herein includes undoped graphene and heteroatom-doped graphene such as N-doped quantum dots (NGQDs) and S-doped quantum dots (SGQDs). In an embodiment, the graphene is undoped graphene only. Polymer substrates are exposed to a laser source and graphene is formed from the polymer. Graphene layers are generated on a surface of the polymer substrate, resulting in new surface characteristics. Such characteristics can include increased surface area, thermal conductivity, electrical conductivity, hydrophobicity, antimicrobial properties, or a combination thereof. The performance of such nanocomposites depend on the polymer, morphology of the polymer substrate, and the laser parameters used. Laser-induced graphene formation can provide greater conductivity than mixing methods, which typically use graphite. Accordingly, laser-induced graphene formation can provide improved conductivity compared to polymers including graphite that are produced by mixing methods.

Laser-induced graphene formation can also be used to produce localized concentrations of graphene in an article. For example, an article (e.g., a substrate layer) can be masked and irradiated to produce graphene in the unmasked regions. This technique allows the production of complex articles that would otherwise need to be manufactured by making graphene-containing and nongraphene-containing parts, and assembling the parts to provide the graphene- and nongraphene-containing regions.

Irradiation conditions, for example, using a carbon dioxide infrared laser, can include a wavelength in a range of 8.3 to 11 μm, or 8.3 to 10.6 μm. The polymer can be irradiated using a laser, operating conditions of which can include power in a range of 0.1 to 0.6 W, laser speed in a range of 1.7 to 2.5 cm s¹, pulse duration in a range of 10 to 30 is, and resolution in a range of 500 to 1,000 pixels per inch (ppi). Adjusting one or more of the operating conditions of the laser, such as the wavelength, power, pulse, speed, gas environment, or the like, can adjust a property of the polymer/graphene nanocomposite.

In an embodiment, the polyetherimide and polycarbonate polymer blend can include polyetherimide in an amount of 10 to 90 volume percent; and polycarbonate in an amount of 90 to 10 volume percent, each based on a total volume of the polymer blend. In an embodiment, the polymer blend can be miscible. In an embodiment, the polymer blend can be clear, according to ASTM D1003-00.

Polyetherimides comprise more than 1, for example 2 to 1000, or 5 to 500, or 10 to 100 structural units of formula (1)

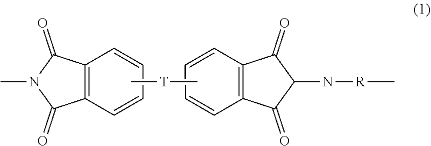

wherein each R is independently the same or different, and is a substituted or unsubstituted divalent organic group, such as a substituted or unsubstituted C₆₋₂₀ aromatic hydrocarbon group, a substituted or unsubstituted straight or branched chain C₄₋₂₀ alkylene group, a substituted or unsubstituted C₃₋₈ cycloalkylene group, in particular a halogenated derivative of any of the foregoing. In some embodiments R is divalent group of one or more of the following formulas (2)

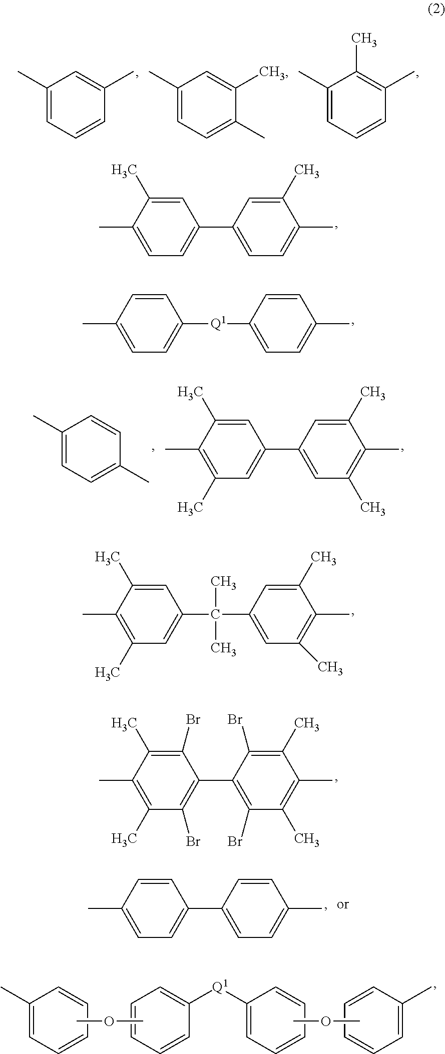

wherein Q¹ is —O—, —S—, —C(O)—, —SO₂—, —SO—, —P(R^{a})(═O)— wherein R^{a} is a C₁₋₈ alkyl or C₆₋₁₂ aryl, —C_{y}H_{2y}— wherein y is an integer from 1 to 5 or a halogenated derivative thereof (which includes perfluoroalkylene groups), or —(C₆H₁₀)_{z}— wherein z is an integer from 1 to 4. In some embodiments R is m-phenylene, p-phenylene, or a diarylene sulfone, in particular bis(4,4′-phenylene)sulfone, bis(3,4′-phenylene)sulfone, bis(3,3′-phenylene)sulfone, or a combination comprising at least one of the foregoing. In some embodiments, at least 10 mole percent or at least 50 mole percent of the R groups contain sulfone groups, and in other embodiments no R groups contain sulfone groups.

Further in formula (1), T is —O— or a group of the formula —O—Z—O— wherein the divalent bonds of the —O— or the —O—Z—O— group are in the 3,3′, 3,4′, 4,3′, or the 4,4′ positions, and Z is an aromatic C₆₋₂₄ monocyclic or polycyclic moiety optionally substituted with 1 to 6 C₁₋₈ alkyl groups, 1 to 8 halogen atoms, or a combination comprising at least one of the foregoing, provided that the valence of Z is not exceeded. Exemplary groups Z include groups of formula (3)

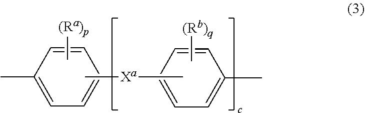

wherein R^{a} and R^{b} are each independently the same or different, and are a halogen atom or a monovalent C₁₋₆ alkyl group, for example; p and q are each independently integers of 0 to 4; c is 0 to 4; and X^{a} is a bridging group connecting the hydroxy-substituted aromatic groups, where the bridging group and the hydroxy substituent of each C₆ arylene group are disposed ortho, meta, or para (specifically para) to each other on the C₆ arylene group. The bridging group X^{a} can be a single bond, —O—, —S—, —S(O)—, —S(O)₂—, —C(O)—, or a C₁₋₁₈ organic bridging group. The C₁₋₁₈ organic bridging group can be cyclic or acyclic, aromatic or non-aromatic, and can further comprise heteroatoms such as halogens, oxygen, nitrogen, sulfur, silicon, or phosphorous. The C₁₋₁₈ organic group can be disposed such that the C₆ arylene groups connected thereto are each connected to a common alkylidene carbon or to different carbons of the C₁₋₁₈ organic bridging group. A specific example of a group Z is a divalent group of formula (3a)

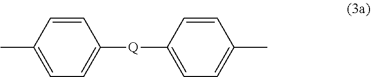

wherein Q is —O—, —S—, —C(O)—, —SO₂—, —SO—, —P(R^{a})(═O)— wherein R^{a} is a C₁₋₈ alkyl or C₆₋₁₂ aryl, or —C_{y}H_{2y}— wherein y is an integer from 1 to 5 or a halogenated derivative thereof (including a perfluoroalkylene group). In a specific embodiment Z is a derived from bisphenol A, such that Q in formula (3a) is 2,2-isopropylidene.

In an embodiment in formula (1), R is m-phenylene, p-phenylene, or a combination comprising at least one of the foregoing, and T is —O—Z—O— wherein Z is a divalent group of formula (3a). Such materials are available under the trade name ULTEM from SABIC. Alternatively, R is m-phenylene, p-phenylene, or a combination comprising at least one of the foregoing, and T is —O—Z—O wherein Z is a divalent group of formula (3a) and Q is 2,2-isopropylidene. Alternatively, the polyetherimide can be a copolymer comprising additional structural polyetherimide units of formula (1) wherein at least 50 mole percent (mol %) of the R groups are bis(4,4′-phenylene)sulfone, bis(3,4′-phenylene)sulfone, bis(3,3′-phenylene)sulfone, or a combination comprising at least one of the foregoing and the remaining R groups are p-phenylene, m-phenylene or a combination comprising at least one of the foregoing; and Z is 2,2-(4-phenylene)isopropylidene, i.e., a bisphenol A moiety. In some embodiments, the polyetherimide is a copolymer that optionally comprises additional structural imide units that are not polyetherimide units. These additional structural imide units preferably comprise less than 20 mol % of the total number of units, and more preferably can be present in amounts of 0 to 10 mol % of the total number of units, or 0 to 5 mol % of the total number of units, or 0 to 2 mole % of the total number of units. In some embodiments, no additional imide units are present in the polyetherimide.

The polyetherimide can be a copolymer, for example, a poly(etherimide-sulfone) copolymer comprising structural units of formula (1) wherein at least 50 mole % of the R groups are of formula (2) wherein Q¹ is —SO₂— and the remaining R groups are independently p-phenylene or m-phenylene or a combination comprising at least one of the foregoing; and Z is 2,2′-(4-phenylene)isopropylidene. In an embodiment, polyetherimide sulfone can include a phthalic anhydride end group, an example of which is commercially available under the trade name EXTEM XH1015 from SABIC.

The polyetherimides can have a melt index of 0.1 to 10 grams per minute (g/min), as measured by American Society for Testing Materials (ASTM) D1238 at 340 to 370° C., using a 6.7 kilogram (kg) weight. In some embodiments, the polyetherimide has a weight average molecular weight (Mw) of 1,000 to 150,000 grams/mole (Dalton), as measured by gel permeation chromatography, using polystyrene standards. In some embodiments the polyetherimide has an Mw of 10,000 to 80,000 Daltons. Such polyetherimides typically have an intrinsic viscosity greater than 0.2 deciliters per gram (dl/g), or, more specifically, 0.35 to 0.7 dl/g as measured in m-cresol at 25° C.

“Polycarbonate” as used herein means a homopolymer or copolymer having repeating structural carbonate units of formula (7)

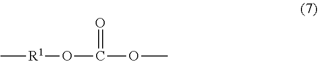

wherein at least 60 percent of the total number of R¹ groups are aromatic, or each R¹ contains at least one C₆₋₃₀ aromatic group. Specifically, each R¹ can be derived from a dihydroxy compound such as an aromatic dihydroxy compound of formula (8) or a bisphenol of formula (9).

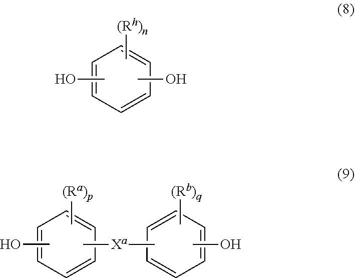

In formula (8), each R^{h} is independently a halogen atom, for example bromine, a C₁₋₁₀ hydrocarbyl group such as a C₁₋₁₀ alkyl, a halogen-substituted C₁₋₁₀ alkyl, a C₆₋₁₀ aryl, or a halogen-substituted C₆₋₁₀ aryl, and n is 0 to 4. In formula (9), R^{a} and R^{b} are each independently a halogen, C₁₋₁₂ alkoxy, or C₁₋₁₂ alkyl, and p and q are each independently integers of 0 to 4, such that when p or q is less than 4, the valence of each carbon of the ring is filled by hydrogen. In an embodiment, p and q is each 0, or p and q is each 1, and R^{a} and R^{b} are each a C₁₋₃ alkyl group, specifically methyl, disposed meta to the hydroxy group on each arylene group. X^{a} is a bridging group connecting the two hydroxy-substituted aromatic groups, where the bridging group and the hydroxy substituent of each C₆ arylene group are disposed ortho, meta, or para (specifically para) to each other on the C₆ arylene group, for example, a single bond, —O—, —S—, —S(O)—, —S(O)₂—, —C(O)—, or a C₁₋₁₈ organic group, which can be cyclic or acyclic, aromatic or non-aromatic, and can further comprise heteroatoms such as halogens, oxygen, nitrogen, sulfur, silicon, or phosphorous. For example, X^{a} can be a substituted or unsubstituted C₃₋₁₈ cycloalkylidene; a C₁₋₂₅ alkylidene of the formula —C(R^{e})(R^{d})— wherein R^{c} and R^{d} are each independently hydrogen, C₁₋₁₂ alkyl, C₁₋₁₂ cycloalkyl, C₇₋₁₂ arylalkyl, C₁₋₁₂ heteroalkyl, or cyclic C₇₋₁₂ heteroarylalkyl; or a group of the formula —C(═R^{e})— wherein R^{e} is a divalent C₁₋₁₂ hydrocarbon group.

Some illustrative examples of dihydroxy compounds that can be used are described, for example, in WO 2013/175448 A1, US 2014/0295363, and WO 2014/072923. Specific dihydroxy compounds include resorcinol, 2,2-bis(4-hydroxyphenyl) propane (“bisphenol A” or “BPA”), 3,3-bis(4-hydroxyphenyl) phthalimidine, 2-phenyl-3,3′-bis(4-hydroxyphenyl) phthalimidine (also known as N-phenyl phenolphthalein bisphenol, “PPPBP”, or 3,3-bis(4-hydroxyphenyl)-2-phenylisoindolin-1-one), 1,1-bis(4-hydroxy-3-methylphenyl)cyclohexane, and 1,1-bis(4-hydroxyphenyl)-3,3,5-trimethylcyclohexane (isophorone bisphenol).

The polycarbonate can be a copolycarbonate, i.e., a polycarbonate having two or more different carbonate units. Specific copolycarbonates include bisphenol A carbonate units and bulky bisphenol carbonate units, i.e., derived from bisphenols containing at least 12 carbon atoms, for example 12 to 60 carbon atoms or 20 to 40 carbon atoms. Examples of such copolycarbonates include copolycarbonates comprising bisphenol A carbonate units and 2-phenyl-3,3′-bis(4-hydroxyphenyl) phthalimidine carbonate units (a BPA-PPPBP copolymer, commercially available under the trade name XHT from SABIC), a copolymer comprising bisphenol A carbonate units and 1,1-bis(4-hydroxy-3-methylphenyl)cyclohexane carbonate units (a BPA-DMBPC copolymer commercially available under the trade name DMC from SABIC), and a copolymer comprising bisphenol A carbonate units and isophorone bisphenol carbonate units (available, for example, under the trade name APEC from Bayer).

The polycarbonate can be a polycarbonate copolymer such as a poly(carbonate-ester. Poly(carbonate-ester)s further contain, in addition to recurring carbonate chain units of formula (7), repeating ester units of formula (10)

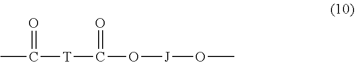

wherein J is a divalent group derived from a dihydroxy compound (which includes a reactive derivative thereof), and can be, for example, a C₁₋₁₀ alkylene, a C₆₋₂₀ cycloalkylene, a C₅₋₂₀ arylene, or a polyoxyalkylene group in which the alkylene groups contain 2 to 6 carbon atoms, specifically, 2, 3, or 4 carbon atoms; and T is a divalent group derived from a dicarboxylic acid (which includes a reactive derivative thereof), and can be, for example, a C₁₋₂₀ alkylene, a C₅₋₂₀ cycloalkylene, or a C₆₋₂₀ arylene. Copolyesters containing a combination of different T or J groups can be used. The polyester units can be branched or linear.

Specific dihydroxy compounds include aromatic dihydroxy compounds of formula (8) (e.g., resorcinol), bisphenols of formula (9) (e.g., bisphenol A), a C₁₋₈ aliphatic diol such as ethane diol, n-propane diol, i-propane diol, 1,4-butane diol, 1,4-cyclohexane diol, 1,4-hydroxymethylcyclohexane, or a combination comprising at least one of the foregoing dihydroxy compounds. Aliphatic dicarboxylic acids that can be used include C₅₋₂₀ aliphatic dicarboxylic acids (which includes the terminal carboxyl groups), specifically linear C₈₋₁₂ aliphatic dicarboxylic acid such as decanedioic acid (sebacic acid); and alpha, omega-C₁₂ dicarboxylic acids such as dodecanedioic acid (DDDA). Aromatic dicarboxylic acids that can be used include terephthalic acid, isophthalic acid, naphthalene dicarboxylic acid, 1,4-cyclohexane dicarboxylic acid, or a combination comprising at least one of the foregoing acids. A combination of isophthalic acid and terephthalic acid wherein the weight ratio of isophthalic acid to terephthalic acid is 91:9 to 2:98 can be used.

Specific ester units include ethylene terephthalate units, n-proplyene terephthalate units, n-butylene terephthalate units, ester units derived from isophthalic acid, terephthalic acid, and resorcinol (ITR ester units), and ester units derived from sebacic acid and bisphenol A. The molar ratio of ester units to carbonate units in the poly(ester-carbonate)s can vary broadly, for example 1:99 to 99:1, specifically, 10:90 to 90:10, more specifically, 25:75 to 75:25, or from 2:98 to 15:85. In some embodiments the molar ratio of ester units to carbonate units in the poly(ester-carbonate)s can vary from 1:99 to 30:70, specifically 2:98 to 25:75, more specifically 3:97 to 20:80, or from 5:95 to 15:85.

Poly(carbonate aliphatic ester)s can be used, such as those comprising bisphenol A carbonate units and sebacic acid-bisphenol A ester units, such as those commercially available under the trade name LEXAN HFD from SABIC.

A specific poly(carbonate-ester) that can be used is a poly(aromatic ester-carbonate) comprising bisphenol A carbonate units and isophthalate-terephthalate-bisphenol A ester units, also commonly referred to as poly(carbonate-ester)s (PCE) or poly(phthalate-carbonate)s (PPC), depending on the relative ratio of carbonate units and ester units. Another specific poly(ester-carbonate) comprises bisphenol A carbonate units and resorcinol isophthalate and terephthalate units. Such poly(carbonate-ester)s are commercially available under the trade name LEXAN SLX from SABIC.

A poly(carbonate-siloxane) can be used, comprising carbonate units and diorganosiloxane units. In an embodiment, the poly(carbonate-siloxane) comprises bisphenol A carbonate units and dimethylsiloxane units, for example blocks containing 5 to 200 dimethylsiloxane units, such as those commercially available under the trade name EXL from SABIC.

Other specific polycarbonates that can be used include poly(carbonate-ester-siloxane)s comprising carbonate units, ester units and diorganosiloxane units. In an embodiment, the include poly(carbonate-ester-siloxane)s comprise bisphenol A carbonate units, isophthalate-terephthalate-bisphenol A ester units, and blocks containing 5 to 200 dimethylsiloxane units. These are commercially available under the trade name FST from SABIC.

The polycarbonates can have an intrinsic viscosity, as determined in chloroform at 25° C., of 0.3 to 1.5 deciliters per gram (dl/gm), specifically 0.45 to 1.0 dl/gm. The polycarbonates can have a weight average molecular weight (Mw) of 10,000 to 200,000 Daltons (Da), specifically 20,000 to 100,000 Da, as measured by gel permeation chromatography (GPC), using a crosslinked styrene-divinylbenzene column and calibrated to bisphenol A homopolycarbonate references. GPC samples can be prepared at a concentration of 1 mg per ml, and are eluted at a flow rate of 1.5 ml per minute. In an embodiment, the polycarbonate can have an Mw of 15,000 to 28,000 Da, preferably 15,000 to 27,000 Da, more preferably 18,000 to 26,000 Da, as measured by GPC.

In an embodiment, the polycarbonate can include a homopolycarbonate, preferably a bisphenol A homopolycarbonate, more preferably a preferably a bisphenol A homopolycarbonate having a weight average molecular weight of 19,000 to 22,000 Da.

In an embodiment, the polymer/graphene nanocomposite has a volume or surface electrical conductivity of 10 to 1,000 S/m, or other desirable property, for example a gas barrier property. In a further advantage, the graphene particles can exhibit good adhesion to the polymer matrix after laser irradiation. Use of irradiation to produce polymer/graphene nanocomposites can obviate one or more disadvantages of using mixing methods to manufacture such nanocomposites.

A polymer/graphene nanocomposite made by the above method is disclosed.

A polymer/graphene nanocomposite comprises polymer-derived graphene and a polymer blend comprising a polyetherimide and a polycarbonate.

The polymer/graphene nanocomposite can be used in a wide variety of articles, in particular articles using surface conductivity.

This disclosure is further illustrated by the following examples, which are non-limiting.

### EXAMPLES

Components used in the Examples and Comparative Examples are provided in Table 1.

TABLE 1

| Component | Description | Source |
|---|---|---|
| PEI | Polyetherimide derived from bisphenol A and meta-phenylene diamine, Tg = 215 to | SABIC |
| | 219° C.; Mn = 20,000 to 22,000 Da; Mw = 52,000 to 56,000 Da; polydispersity = | |
| | 2.4 to 2.6 (available as ULTEM ™ 1000) | |
| PC_{low} | Bisphenol A homopolycarbonate having an Mw of 21,000 to 22,000 Da (trade | SABIC |
| | name LEXAN 175) | |
| PC_{middle} | Bisphenol A homopolycarbonate having an Mw of 29,000 to 32,000 Da (trade | SABIC |
| | name LEXAN 105) | |
| PC_{high} | Bisphenol A homopolycarbonate having an Mw of 34,000 to 36,000 Da (trade | SABIC |
| | name LEXAN 135) | |
| PC_{very low} | Bisphenol A homopolycarbonate having an Mw of 18,000 to 20,0000 Da (trade | SABIC |
| | name LEXAN 115) | |
| ITR-PC | Isophthaloyl/terephthaloyl resorcinol poly(carbonate-ester) (trade name SLX) | SABIC |
| PETS | Pentaerythritol stearate (>90% esterified) | FACI |
| AO | Tris(di-t-butylphenyl)phosphite (anti-oxidant) | Everspring |

Compounding and extrusion were performed at standard conditions. In particular, extrusion of all materials was performed on a 25 mm Werner-Pfleiderer ZAK twin-screw extruder (L/D ratio of 33/1) with a vacuum port located near the die face. The extruder has 9 zones, which were set at temperatures of 40° C. (feed zone), 200° C. (zone 1), 250° C. (zone 2), 270° C. (zone 3), and 280-300° C. (zone 4 to 8). Screw speed was 300 rpm and throughput was between 15 and 25 kg/hr.

For testing, color plaques (60×60×2.0 millimeters (mm)) were prepared by drying the compositions at 135° C. for 4 hours, then by molding after on a 45-ton Engel molding machine with 22 mm screw or 75-ton Engel molding machine with 30 mm screw operating at a temperature around 310° C. with a mold temperature of 100° C. Films (210×297×0.250 mm and 210×297×0.250 mm) were obtained from SABIC.

Carbon dioxide infrared laser irradiation conditions for the Comparative Examples and the Examples are provided in Table 2. Irradiation was further conducted under ambient conditions of temperature and pressure.

TABLE 2

| Parameter | Value |
|---|---|
| Wavelength (μm) | 10.6 |
| Power (W) | 0.1-0.6 |
| Laser speed (cms⁻¹) | 1.7-2.5 |
| Pulse duration (μs) | 14.6 |
| Resolution (pixels per inch (ppi)) | 600 |

Melt volume rate (MVR) was determined at 360° C./5.0 kg in accordance with ISO 1133. Results are reported in units of cm³/10 minutes. Viscosity is equal to an inverse of the MVR.

Weight average molecular weight (Mw) was determined by gel permeation chromatography (GPC).

The overall microstructural properties of polymer/graphene nanocomposites were studied by scanning electron microscopy (SEM).

Specific surface area (porosity) was determined using SEM. A scanning electron microscope (ESEM, JSF 7800F, JEOL, Tokyo, Japan) was used to acquire micrographs of graphene nanocomposite 3D sponge and microstructures and fiber like microstructures with dispersion of graphene nanoparticles at an acceleration voltage of 10 kV. For SEM examination, the samples were sputter-coated with Pd/Pt. Results are reported in units of m²·g⁻¹.

Raman spectroscopy (Bruker Senterra dispersive microscope Raman) was used to confirm creation of graphene after laser irradiation for various samples at laser wavelength 532 nm (2 Mw) with objective of 100× in scanning range 4400-200 cm⁻¹.

Degree of graphitization was determined by calculating intensity of peaks (2D, G, D) position, shape of spectra, according to ISO TC 201 (Surface Chemical Analysis) and further according to the Versailles Project on Advanced Materials and Standards by VAMAS TWA41—Graphene and VAMAS TWA42—Raman. The polymer/graphene nanocomposite formed by the irradiation can have a degree of graphitization of 0.5 to 2.0, for example 0.5 to 1.0.

Electrical volume resistivity measurements were conducted in a thickness direction using Jandel 4-point probe with spacing of 1 mm at 90 volts (V), according to ASTM 257-75, and converted to conductivity values. Each conductivity value reported is an average of the calculated conductivity at ten locations along a line on the sample. Results are reported in units of S/m.

As used herein, “2D band” can be correlated to a single graphene layer. Single layer graphene can also be identified by analyzing the peak intensity ratio of the 2D and G bands.

The adhesion of graphene particles to the polymer were determined by tape file, and are reported relative to each other, where each “+” indicates better adhesion.

The compositions of Examples 1-6 (Ex1-6) and Comparative Examples 1-4 (CEx1-4) are shown in Table 3, together with their measured properties. The amount of each component is in volume percent, based on the total volume of the composition, and totals 100.00 volume percent.

TABLE 3

| | CEx1 | CEx2 | CEx3 | CEx4 | Ex1 | Ex2 | Ex3 | Ex4 | Ex5 | Ex6 |
|---|---|---|---|---|---|---|---|---|---|---|
| Component | | | | | | | | | | |
| PEI | 50.00 | 80.00 | 50.00 | 80.00 | 50.00 | 80.00 | 50.00 | 20.00 | 50.00 | 80.00 |
| PC_{very low} | | | | | | | 50.00 | | | |
| PC_{low} | | | | | 50.00 | 20.0 | | | | |
| PC_{middle} | | | 50.00 | 20.00 | | | | | | |
| PC_{high} | 50.00 | 20.00 | | | | | | | | |
| ITR-PC | | | | | | | | 80.00 | 50.00 | 20.00 |
| Properties | | | | | | | | | | |
| Mw PC composition | 44.5 | 35.0 | 42.0 | 30.5 | 37.9 | 21.8 | 36.4 | | | |
| Blend MVR, 360° C./5.0 kg | 10 | 16 | 11.5 | 15 | 22 | 13.5 | 49 | 16.8 | 16.4 | |
| Electrical conductivity before laser | 0 | 0 | 0 | 0 | 0 | 0 | 0 | 0 | 0 | 0 |
| irradiation | | | | | | | | | | |
| Electrical conductivity after laser | 150 | 200 | 150 | 200 | 100 | 200 | 100 | 100 | 170 | 190 |
| irradiation | | | | | | | | | | |
| Specific surface area before laser | 0 | 0 | 0 | 0 | 0 | 0 | 0 | 0 | 0 | 0 |
| irradiation | | | | | | | | | | |
| Specific surface area after laser | 300 | 340 | 280 | 340 | 200 | 340 | 100 | 300 | 250 | 250 |
| irradiation | | | | | | | | | | |
| Degree of graphitization before | 0 | 0 | 0 | 0 | 0 | 0 | 0 | 0 | 0 | 0 |
| laser irradiation | | | | | | | | | | |
| Degree of graphitization after laser | 0.74 | 0.8 | 0.70 | 0.80 | 0.70 | 0.80 | 0.70 | 0.70 | 0.74 | 0.77 |
| irradiation | | | | | | | | | | |
| 2D band before laser irradiation | No | No | No | No | No | No | No | No | No | No |
| 2D band after laser irradiation | Yes | Yes | Yes | Yes | Yes | Yes | Yes | Yes | Yes | Yes |
| Adhesion of graphene particles on | − | − | − | − | − | − | − | − | − | − |
| polymer before laser irradiation | | | | | | | | | | |
| Adhesion of graphene particles on | ++ | + | ++ | + | +++ | +++ | +++ | + | + | + |
| polymer after laser irradiation | | | | | | | | | | |

### Comparative Examples 1-4 and Examples 1-3—PEI and PC

The effect of different PCs on adhesion of graphene particles on a polymer matrix including PEI and the PC are summarized in Table 3. In particular, very low and low viscosity PC provided improved adhesion as compared to middle or high viscosity PC. Further, the polymer blend including PEI and the low viscosity PC provided desirable electrical conductivity after laser irradiation.

More specifically, very good adhesion was obtained with a MVR in a range of 13.5-49 cm³/10 minutes.

### Examples 4-6—ITR-PC and PEI

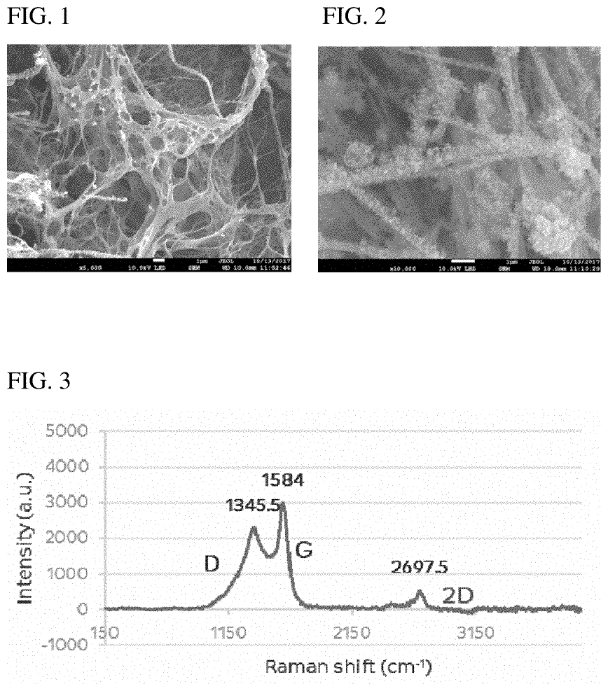

SEM images of Ex6 showed 3-dimensional pores and fiber-like microstructures with dispersion of graphene nanoparticles on the fibers after laser irradiation (FIGS. 1 and 2). Raman spectroscopy confirmed graphitization of Ex6 by laser irradiation, by the presence of D, G and 2D peaks (FIG. 3). The 2D peak at 2,700 cm⁻¹ corresponds to a single layer graphene with electrical conductivity around 6,000 S/cm.

Blends of ITR-PC and PEI exhibited adhesion, while also providing desirable electrical conductivity after laser irradiation.

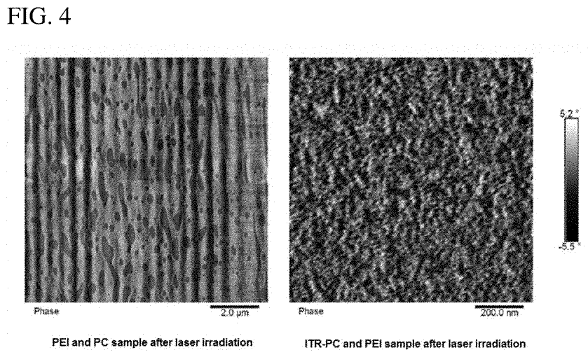

FIG. 4 shows atomic force microscopy (AFM) images of an immiscible PEI and PC sample after laser irradiation and a miscible ITR-PC and PEI sample after laser irradiation. As can be seen in FIG. 4, the morphology of the immiscible sample differs from that of the miscible sample. Adhesion of the immiscible sample was greater than adhesion of the miscible sample.

This disclosure further encompasses the following aspects.

Aspect 1. A method for forming a polymer/graphene nanocomposite, the method comprising: providing a polyetherimide and a polycarbonate polymer blend; and irradiating the polymer blend with radiation comprising a wavelength in a range of 8.3 to 11 μm, or 8.3 to 10.6 μm to provide the polymer/graphene nanocomposite, wherein the polymer blend has a melt volume rate of 1 to 100 cm³/10 min, preferably 5 to 75 cm³/10 min, more preferably 10 to 50 cm³/10 min, as determined at 360° C./5.0 kg in accordance with ISO 1133.

Aspect 2. The method according to Aspect 1, wherein: irradiating the polymer blend comprises using a laser, and operating conditions of the laser comprise power in a range of 0.1 to 0.6 W, laser speed in a range of 1.7 to 2.5 cm s⁻¹, pulse duration in a range of 10 to 30 μs, and resolution in a range of 500 to 1,000 ppi.

Aspect 3. The method according to Aspect 2, further comprising adjusting one or more of the operating conditions of the laser to adjust a property of the polymer/graphene nanocomposite.

Aspect 4. The method according to any preceding aspect, wherein the polycarbonate has a molecular weight of 15,000 to 28,000 Da, preferably 16,000 to 27,000 Da, more preferably 18,000 to 26,000 Da, as measured by gel permeation chromatography.

Aspect 5. The method according to any preceding aspect, wherein the polycarbonate is a polycarbonate homopolymer, a copolycarbonate, a poly(carbonate-ester), a poly(carbonate-siloxane), a poly(carbonate-ester-siloxane), or a combination thereof.

Aspect 6. The method according to any preceding aspect, wherein the polycarbonate comprises a poly(carbonate-ester), a poly(carbonate-siloxane), a poly(carbonate-ester-siloxane), preferably an isophthaloyl/terephthaloyl resorcinol poly(carbonate-ester).

Aspect 7. The method according to any of Aspects 1 to 5, wherein the polycarbonate comprises a homopolycarbonate, preferably a bisphenol A homopolycarbonate, more preferably a preferably a bisphenol A homopolycarbonate having a molecular weight of 19 to 22 kiloDalton.

Aspect 9. The method according to any preceding aspect, wherein the polymer blend comprises: the polyetherimide in an amount of 10 to 90 volume percent; and the polycarbonate in an amount of 90 to 10 volume percent, each based on a total volume of the polymer blend.

Aspect 10. The method according to any preceding aspect, wherein the polymer blend is miscible.

Aspect 11. The method according to any preceding aspect, wherein the polymer blend has a haze of less than 15%, measured according to ASTM D1003-00 using the color space CIE1931 (Illuminant C and a 2° observer) at a sample thickness of 2.5 mm.

Aspect 12. The method according to any preceding aspect, wherein the polymer/graphene nanocomposite has an electrical conductivity of 10 to 1,000 S/m, measured according to ASTM 257-75.

Aspect 13. The method according to any preceding aspect, wherein the polymer/graphene nanocomposite has a degree of graphitization of 0.5 to 2, measured according to ISO TC 201 (Surface Chemical Analysis) and further according to the Versailles Project on Advanced Materials and Standards by VAMAS TWA41—Graphene and VAMAS TWA42—Raman.

Aspect 14. The method according to any preceding aspect, wherein the polymer/graphene nanocomposite has a greater degree of adhesion compared to a second polymer blend comprising the same polyetherimide and polycarbonate in the same amount, the second polymer blend having a melt volume rate of greater than 100 cm³/10, as determined at 360° C./5.0 kg in accordance with ISO 1133, the second polymer blend not having been irradiated with radiation comprising a wavelength in a range of 8.3 to 11 μm, or 8.3 to 10.6 μm.

Aspect 15. A polymer/graphene nanocomposite formed by the method of any one of the preceding aspects.

Aspect 16. A polymer/graphene nanocomposite comprising a blend comprising a polyetherimide and a polycarbonate; and polymer-derived graphene.

Aspect 17. The polymer/graphene nanocomposite of Aspect 15 or aspect 16, wherein the polymer/graphene nanocomposite has an electrical conductivity of 10 to 1,000 S/m, measured according to ASTM 257-75.

Aspect 18. An article comprising the polymer/graphene nanocomposite of Aspect 16 or Aspect 17.

The compositions, methods, and articles can alternatively comprise, consist of, or consist essentially of, any appropriate materials, steps, or components herein disclosed. The compositions, methods, and articles can additionally, or alternatively, be formulated so as to be devoid, or substantially free, of any materials (or species), steps, or components, that are otherwise not necessary to the achievement of the function or objectives of the compositions, methods, and articles.

All ranges disclosed herein are inclusive of the endpoints, and the endpoints are independently combinable with each other (e.g., ranges of “up to 25 wt. %, or, more specifically, 5 wt. % to 20 wt. %”, is inclusive of the endpoints and all intermediate values of the ranges of “5 wt. % to 25 wt. %,” etc.). “Combination” is inclusive of blends, mixtures, alloys, reaction products, and the like. The term “a combination thereof” in reference to a list of alternatives is open, i.e., includes at least one of the listed alternatives, optionally with a like alternative nots listed. The terms “a” and “an” and “the” do not denote a limitation of quantity, and are to be construed to cover both the singular and the plural, unless otherwise indicated herein or clearly contradicted by context. “Or” means “and/or” unless clearly stated otherwise. Reference throughout the specification to “some embodiments”, “an embodiment”, and so forth, means that a particular element described in connection with the embodiment is included in at least one embodiment described herein, and may or may not be present in other embodiments. In addition, it is to be understood that the described elements may be combined in any suitable manner in the various embodiments.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this application belongs. All cited patents, patent applications, and other references are incorporated herein by reference in their entirety. However, if a term in the present application contradicts or conflicts with a term in the incorporated reference, the term from the present application takes precedence over the conflicting term from the incorporated reference.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

What is claimed is:

1. A method for forming a polymer/graphene nanocomposite, the method comprising:
providing a polymer blend comprising a polyetherimide and a polycarbonate; and
irradiating the polymer blend with radiation comprising a wavelength in a range of 8.3 to 11 μm to provide the polymer/graphene nanocomposite,
wherein the polymer blend has a melt volume rate of 1 to 100 cm³/10 min, as determined at 360° C./5.0 kg in accordance with ISO 1133.

2. The method according to claim 1, wherein:
irradiating the polymer blend comprises using a laser, and
operating conditions of the laser comprise power in a range of 0.1 to 0.6 W, laser speed in a range of 1.7 to 2.5 cm s⁻¹, pulse duration in a range of 10 to 30 μs, and resolution in a range of 500 to 1,000 ppi.

3. The method according to claim 2, further comprising adjusting one or more of the operating conditions of the laser.

4. The method according to claim 1, wherein the polycarbonate is a polycarbonate homopolymer, a copolycarbonate, a poly(carbonate-ester), a poly(carbonate-siloxane), a poly(carbonate-ester-siloxane), or a combination thereof.

5. The method according to claim 1, wherein the polycarbonate comprises a poly(carbonate-ester).

6. The method according to claim 1, wherein the polycarbonate comprises an isophthaloyl/terephthaloyl resorcinol poly(carbonate-ester).

7. The method according to claim 1, wherein the polycarbonate comprises a homopolycarbonate.

8. The method according to claim 1, wherein the polycarbonate comprises a bisphenol A homopolycarbonate.

9. The method according to claim 1, wherein the polycarbonate comprises a bisphenol A homopolycarbonate having a molecular weight of 19,000 to 22,000 Dalton as determined by gel permeation chromatography.

10. The method according to claim 1, wherein the polymer blend comprises:
the polyetherimide in an amount of 10 to 90 volume percent; and
the polycarbonate in an amount of 90 to 10 volume percent,
each based on a total volume of the polymer blend.

11. The method according to claim 1, wherein the polymer blend is miscible.

12. The method according to claim 7, wherein the polymer blend is immiscible.

13. The method according to claim 1, wherein the polymer blend has a haze of less than 15%, measured according to ASTM D1003-00 using the color space CIE1931 (Illuminant C and a 2° observer) at a sample thickness of 2.5 mm.

14. The method according to claim 1, wherein the polymer/graphene nanocomposite has an electrical conductivity of 10 to 1,000 S/m, measured according to ASTM 257-75.

15. The method according to claim 1, wherein the polymer/graphene nanocomposite has a degree of graphitization of 0.5 to 2, measured according to ISO TC 201 (Surface Chemical Analysis) and further according to Versailles Project on Advanced Materials and Standards by VAMAS TWA41—Graphene and VAMAS TWA42—Raman.

16. The method according to claim 1, wherein the polymer blend has a melt volume rate 10 to 50 cm³/10 min, as determined at 360° C./5.0 kg in accordance with ISO 1133.

17. A polymer/graphene nanocomposite formed by the method of claim 1.

18. A polymer/graphene nanocomposite, comprising:
a polymer comprising a polyetherimide and a polycarbonate; and
polymer-derived graphene.

19. The polymer/graphene nanocomposite according to claim 18, wherein the polymer/graphene nanocomposite has an electrical conductivity of 10 to 1,000 S/m, measured according to ASTM 257-75.

20. An article comprising the polymer/graphene nanocomposite of claim 18.
